(19) United States
(12) Patent Application Publication
(10) Pub. No.: US 2007/0096891 A1
(43) Pub. Date: May 3, 2007

(54) RFID buckle closure and presence sensor system for safety childseat

(76) Inventors: Michael L. Sheriff, Plano, TX (US); Ethan Arthur Funk, Ouray, CO (US)

Correspondence Address: MICHAEL L SHERRARD, 72 DOUD DRIVE, LOS ALTOS, CA, 94022, US

(21) Appl. No.: 11/581,884

(22) Filed: Oct. 17, 2006

Related U.S. Application Data
(60) Provisional application No. 60/596,729, filed on Oct. 17, 2005.
(60) Provisional application No. 60/780,040, filed on Mar. 2, 2006.

(51) Int. Cl. B60Q 1/00

(52) U.S. Cl. 340/457.1; 297/464

(57) ABSTRACT

In the preferred embodiment of the present invention a passive, wireless, RFID-based wireless buckle-closure sensor determines whether the buckle of a child safety seat is secured. Sensors also are provided to determine if the child is in the seat, the temperature and if the vehicle is in operation, and alarms are sounded if an unsafe condition is detected by the system. Child safety seats utilize a 3-point or 5-point locking-mechanism for seat belt and harness restraints. The locking-mechanism requires that metal belt/harness components latch together and are released by depression of a lock-mounted release button. In the preferred embodiment of the present invention a passive RF transponder is affixed to the buckle. Essentially the RF transponder comprises an RFID device without a data component. The RF transponder is interrogated by a frequency-scanning reader, which determines the resonant frequency of the transponder. The resonant frequency of the transponder is affected by the presence of the metal fittings local to the RF transponder. Thus, since the major components of the buckle and latch are metal, the detection of the change in the resonant frequency of the transponder, also referred to as “detuning,” permits the determination of the state of the belt/harness buckle—latched or unlatched. This sensing is wireless, unobtrusive, and requires only a passive component be attached to the buckle. Further disclosed is a method of determining the status of a child in a child safety seat, including: whether or not a child is in the seat, whether or not the belt/harness buckle is latched, whether the vehicle's engine is in operation, and whether or not the surrounding temperature exceeds the temperature range. If an unsafe condition is detected, an alarm is activated.

### CLAIM OF PRIORITY

The present application claims priority from U.S. Provisional Application No. 60/596,729 filed 17 Oct. 2005 titled CHILD BOOSTER SEAT SYSTEM AND ARTICLES USED FOR SAME filed in the name of Michael Lynn Sheriff and U.S. Provisional Application No. 60/780040 filed 02 Mar. 2006 titled RFID BUCKLE CLOSURE AND PRESENCE SENSOR SYSTEM filed in the names of Michael L. Sheriff and Ethan Funk.

### FIELD OF THE INVENTION

The present invention relates to the field of wireless buckle-closure sensors and to the field of child safety seats for automobiles. More particularly, the present invention provides a passive, wireless, RF buckle-closure sensor which has particular applicability in improved child safety seats for automobiles.

### BACKGROUND

Six out of ten children who die in passenger vehicle crashes were unbelted. (National Safety Council, or NSC, 2002). According to the American Academy of Pediatrics, more children are killed as passengers in car crashes than from any other type of injury. One reason is that most children ride unbuckled or improperly restrained.

Children should be securely buckled in the proper type of child safety seat. Infants and toddlers should be secured in child safety seats and convertible rear facing and convertible forward-facing child safety from birth to four years of age. Children between about 40 to 80 lbs., and less than 4 feet 9 inches tall should be secured in a booster seat so that the vehicle lap and shoulder belt fit them properly.

Children should not be left in an unattended vehicle. Left alone for only a few minutes, a small child can be abducted, set the vehicle in motion, or—even on a seemingly mild day—suffer a deadly heatstroke. In 2004, 35 children died of heat stroke in the US after being left unattended in a parked car. Research has shown that when ambient temperatures rise above 35° C., sealed cars reach a suffocating 65° C. in just 15 minutes. Sunlight can heat car interiors to lethal temperatures in just 30 minutes, even if the weather is relatively cool. The researchers strongly urge parents not to leave children alone in parked cars, no matter how mild the weather. (New Scientist.com, July 2005)

Heat related deaths to young children in parked cars: an analysis of 171 fatalities in the United States, 1995-2002. (Join Together, Boston University School of Public Health, Boston, Mass., USA.) Results: A total of 171 fatalities that met the case criteria were identified. Twenty seven percent (46) were children who gained access to unlocked vehicles and 73% (125) were children who were left by adults. More than a quarter of the adults were aware they were leaving children in the vehicles, while half were unaware or forgot. Forty three percent of deaths to children who were left were associated with childcare, that is 54 deaths—32 of those children were left by family members who intended to take them to childcare but forgot and went to work instead; 22 of those children were left by child care providers or drivers.

Accordingly, it is desirable to detect whether or not a child is in his or her safety seat, to detect whether or not the restraining buckle is secured, to detect the temperature and to detect whether or not the vehicle is in operation. Further, it is desirable to enable appropriate alarms if an unsafe condition is indicated. It is further desirable to provide a passive and wireless buckle-closure sensor that can be retrofit onto existing buckle systems.

Examples of prior art child safety seats include: U.S. Pat. No. 6,104,293 and U.S. Pat. No. 5,949,340 describe an alarm that goes off if a child is left in a child seat when the engine goes off. Alarms are emitted from the child seat. U.S. Pat. No. 6,714,132 describes a system for detecting whether a person moves too far away from an infant in a car seat. The person carries a wireless alarm device that couples to the seat wirelessly. From the abstract: “A system and method uses a wireless tether comprising a transmitter and a receiver to alert a caregiver that an object or person has been left unattended. A detector senses the presence of the object, usually a child, located in a position such as a safety seat. The detector couples to the transmitter, which is, located near the object. The transmitter transmits at least one wireless signal when the object is in the position.”

U.S. Pat No. 6,930,614, From the abstract: “if the driver's door is open and the engine is turned off but there still is an occupant in the motor vehicle, an alarm is immediately triggered.” Further, “The occupancy alarm system may provide an interface and an override such that when the occupant remains in a potentially hazardous environment, that state is communicated via the interface and, if monitored by a responsible adult, the alarm can be overridden.

Various types of sensors have been incorporated into the buckle or tongue to sense when a buckle has been properly locked. These include optical, magnetic, electrical, etc. U.S. Pat. No. 6,357,091 to Devereaux, for example, describes a latch sensing seat belt buckle that uses magnetic flux. The described buckle includes a sensor and a magnet. The magnet is movable from a first position to a second position when a lockable element is inserted into the passage of the buckle. The magnet creates a magnetic field of a first flux density acting on the sensor to cause the sensor to provide a first output when the magnet is in the first position. The magnet creates a magnetic field of a second flux density, different than the first flux density, acting on the sensor to cause the sensor to provide a second output, different than the first output, when the magnet is in the second position. US Patent Application US 2005/0057350 describes a child car seat that enables an alarm if a vehicle door opens while the car seat is occupied.

The preferred embodiment of the present invention is also related to the field of RFID (Radio Frequency IDentification). RFID is an automatic identification method, relying on storing and remotely retrieving data using devices called RFID tags or transponders. An RFID tag is a device that can be attached to or incorporated into a product, animal, or person for the purpose of identification using radio waves. Chip-based RFID tags contain silicon chips and antennas. Passive tags require no internal power source, whereas active tags require a power source. RFID tags are typically used with RFID readers which wirelessly communicate with the RFID tags to receive data stored in the RFID tag.

An RFID system typically consists of several components, including tags and tag readers.

In a typical RFID system, individual objects are equipped with a small, inexpensive tag. The tag contains a transponder with a digital memory chip that is given a unique electronic product code. A RFID reader includes an antenna, a transceiver and decoder. The RFID reader emits an RF signal which activates the RFID tag, which then uses the power received from the RF signal to read its digital memory chip and transmit a signal with that information to the RFID reader. Application software then processes the data.

### SUMMARY OF THE INVENTION

In the preferred embodiment of the present invention a passive, wireless, RFID-based buckle-closure sensor determines whether the buckle of a child safety seat is secured. Sensors also are provided to determine if the child is in the seat, to determine the temperature and to determine if the vehicle is in operation. Alarms are sounded if an unsafe condition is detected by the system.

Child safety seats utilize a 3-point or 5-point locking-mechanism for seat belt and harness restraints. Booster seats use the seat belts already available in an automobile. The locking-mechanisms require that metal belt/harness components latch together. They are released by depression of a lock-mounted release button. In the preferred embodiment of the present invention a passive RFID tag is affixed to the buckle. Essentially the RFID tag is a RF transponder which may or may not include a data component. The RF transponder is interrogated by a frequency-scanning reader, which determines the resonant frequency of the transponder. The resonant frequency of the transponder is affected by the presence of the metal fittings local to the RF transponder. Since the major components of the buckle and latch are metal, they affect the resonant frequency and detune the RF transponder from its design frequency. By detecting this change in the resonant frequency of the RF transponder, the state of the belt/harness buckle—latched or unlatched, can be determined This sensing is wireless, unobtrusive, and requires only a small passive component to be attached to the buckle.

Further disclosed is a system of determining the presence of a child in a child safety seat, the temperature in the automobile, and the operating condition of the automobile. If an unsafe condition is detected, an alarm is activated.

### BRIEF DESCRIPTION OF THE FIGURES

FIG. 1 is an illustration of the components of a RFID buckle closure and presence sensor system for a safety child seat in conformance with the preferred embodiment of the present invention.

FIG. 2 is an illustration of an RF sensor tag in conformance with the preferred embodiment of the invention.

FIGS. 3 and 4 illustrate an RF Detector in accordance with the present invention.

FIGS. 5 and 6 are schematic diagrams of a preferred RF detector in accordance with the present invention.

### DETAILED DESCRIPTION OF THE INVENTION

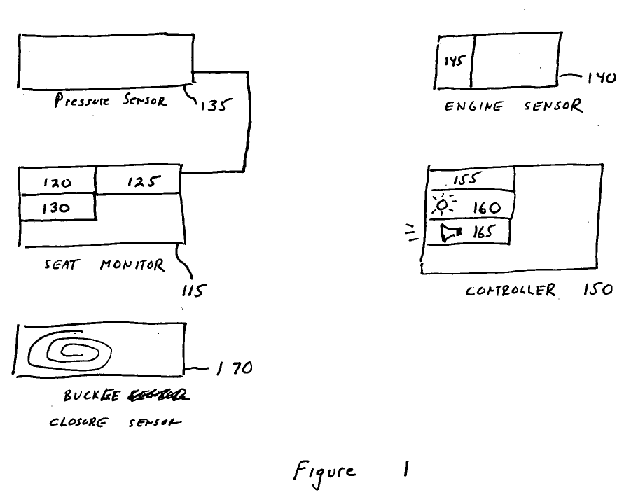

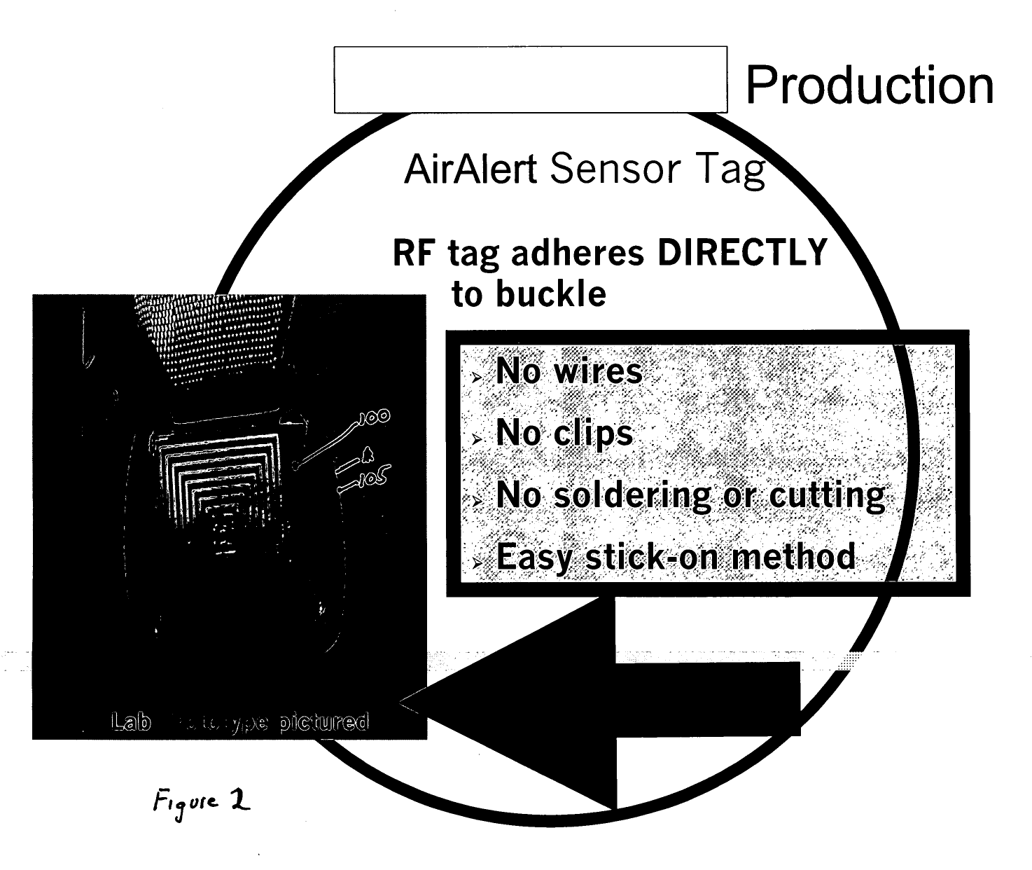

FIG. 1 is an illustration of the components of a RFID buckle-closure sensor and presence sensor system for a safety child seat in conformance with the preferred embodiment of the present invention. Referring to FIG. 1, buckle-closure sensor 170 includes a passive RFID tag device mounted on a buckle portion of the restraining buckle for detecting the latched/unlatched condition of the restraining buckle.

Seat monitor 115 includes a frequency-scanning RF dectector circuit 120 and a wireless receiver/transmitter 125. RF detector circuit 120 is similar in design to a conventional RFID reader. In the preferred embodiment receiver/transmitter 125 is based on the ZigBee specification. Seat monitor 115 further includes a temperature sensor 130. Seat monitor 115 mounts under a child safety seat and includes a battery for power. Alternatively it could receive power from the automobile.

A pressure sensor 135 is mounted on the child seat to detect the presence of a child in the child safety seat. Seat monitor 115 monitors pressure sensor 135 via either hardwire or RF communication. In the case of RF communication, pressure sensor 135 includes a ZigBee transmitter. In an alternative embodiment, other devices, such as thermometers or optical devices could be substituted for the pressure sensor to act as a presence sensor.

Engine sensor 140 determines whether or not the vehicle's engine is in operation and communicates this status (on/off) via a wireless ZigBee transmitter 145. In the preferred embodiment, engine sensor 140 monitors the electromagnetic waves generated by the vehicle's engine when in operation. Other detection systems can be used for automobiles without sparkplugs, such as diesel and electric cars. In an alternative embodiment the ZigBee transmitter 45 could be replaced with a hardwire connection to controller 150.

Controller 150 preferably mounts on the driver's dash or visor and includes a wireless ZigBee receiver/transmitter with integrated antenna for communication with other ZigBee devices, including seat monitor 115 and engine sensor 140. Controller 150 further includes a warning light 160 and an audio alarm 165 and has a cable that plugs into the vehicle's cigarette lighter for primary power. Alternatively, it can be battery-powered.

Controller 150 scans for the presence of RF signals from seat monitor 115 and engine sensor 140. Seat monitor 115 sends a first RF signal when it receives an indication from pressure sensor 135 that it detects weight (i.e. child in seat); and second RF signal indicating the status of buckle-closure sensor 170 (latched or unlatched). If an RF signal is not detected after controller 150 is activated, controller 150 continues to scan until either a RF signal is detected or the engine is turned off. If an RF signal is detected from seat monitor 115 indicating the presence of a child in a child safety seat and the vehicle's engine is in operation, controller 120 expects a RF signal from seat monitor 115 confirming that the buckle is latched. If no RF signal is detected indicating that the buckle is latched, but signals are received indicating presence of a child in a child safety seat and that the vehicle's engine is in operation, controller 125 illuminates a red warning light 160 and alarm 165 emits an audible alert that the child is not restrained, i.e., the buckle is not latched. The warning continues until the buckle is latched or the unsafe condition is otherwise resolved.

Seat monitor 115 activates from power-save “sleep” mode when it receives a signal from pressure sensor 135. It then immediately executes a stored diagnostic routine, which includes a check of its own battery condition. If the diagnostics pass, a “pass” signal is sent to controller 150; if the diagnostics fail, a “failed” signal is sent to controller 150.

Controller 150 activates from power-save “sleep” mode when it receives a signal from seat monitor 115 or when it received an “engine on” signal from engine sensor 140 indicating that the vehicle ignition is switched on and the engine is in operation. Controller 150 then immediately executes a stored diagnostic routine, which includes a check of its own battery condition, and directs seat monitor 115 to execute its diagnostics routine. If both of the diagnostics pass a green light is illuminated. If the diagnostics fail, red alarm light 160 flashes, and an audible alert is sounded from alarm 165.

Controller 150 and seat monitor 115 also function when vehicle engine is not in operation, as indicated by signals from engine sensor 140. Specifically, when controller 150 senses the ignition is off, it begins a pre-determined count down. If, at the end of the count down if it still detects signals from seat monitor 115 indicating the buckle is still latched and pressure sensor 135 still indicates the presence of a child, controller 150 will go into an alarm condition and illuminate red light 160 and emits a loud, constant audible alert via alarm 165. A reset button on controller 120 will reset controller 150 and terminate red light 160 and alarm 165. At reset, controller 120 will begin a new count down. This process will continue until controller 150 no longer receives indication that the child is secured and in the child safety seat while the ignition is off. When controller 150 determines that the child has been removed from vehicle, the count down terminates and controller 150 goes into a power-save, “sleep” mode.

Alerts and alarms from controller 150 are presented in response to a number of conditions including: Low battery power, failed diagnostics, no signal detected from pressure sensor 135 or no signal detected from buckle closure sensor 170. A number of logical alarm conditions are also detected by the preferred embodiment of the present invention. For example, an alarm is provided if a child is in the child safety seat after a pre-set period of time after vehicle engine operation terminates. An alarm is provided if the vehicle temperature is outside a pre-determined range when a child is in the child safety seat. An alarm is provided if the belt/harness buckle on a child safety seat is not buckled when a child is in the seat and the vehicle's engine is in operation.

The preferred embodiment of the present buckle-closure detection system operates by detecting the mutual inductance between two parts of the buckle. The principal of operation is now described.

When an unshielded inductor is in close proximity to, but electrically isolated from, a conducting metal object, some of the magnetic flux lines created by an alternating current through the inductor will pass through the metal object. These flux lines will induce a current in the metal object as if the object were a shorted single turn of wire in a magnetically coupled transformer. If the proximity and shape of the object and inductor allow all the field lines to pass through the metal object, the entire system will behave like a magnetic transformer with a single turn secondary coil which is shorted out. As in a magnetic transformer, the impedance across the primary coil (inductor) will be the primary coil's uncoupled impedance in parallel with the load and coil impedance of the secondary coil multiplied by the square of the secondary to primary coil turns ratio. If the secondary load is near zero ohms (shorted out), and only a single turn, (low inductance) then the primary will also see nearly zero ohms and a very low inductance as well.

If the metal object near the inductor is made smaller, or moved further away from the inductor, less of the inductor's field lines will pass through the object, and the coupling effect will drop proportional to percentage of the field lines that are “mutual” to both the inductor and the object. As the coupling decreases, the impedance across the inductor becomes less affected by the secondary coil effect of the object, until there is no coupling at all and the impedance has risen back to that of the inductor alone.

If the inductor is made part of a resonant circuit, then any mutual magnetic coupling with an electrically isolated conducting object will decrease the inductance seen by the resonant circuit causing the resonant frequency to increase proportional to the coupling.

This principle can be used to detect the insertion of a metal seat belt clip into a buckle. If the buckle has a nearby resonant circuit constructed with a multi-turn coil as the inductive portion of the circuit, the resonant frequency of the circuit will be affected by the insertion of the metal clip into the buckle. By measuring the resonant frequency of the circuit, it can be determined if the metal clip is inserted or not.

In the present invention, this principal of operation is used in conjunction with RFID type devices and readers. Specifically, if a RFID tag is placed near a metal object, such as a metal buckle clip, the frequency of the resonant circuit changes and the system is “detuned.” In fact, RFID tags have a problem when a metal object gets close to the tag. This is because the metal has a very low inductance associated with it, which couples to the inductor on the RFID tag. This lowers the effective inductance of the RFID tag, raising the resonant frequency of the RFID tag, and may raise it so much that the RFID tag is no longer functional. In the RFID literature, this is referred to as “detuning.”

The present buckle-closure sensor system uses this affect to advantage by detecting the shift in the resonant frequency of the detector tag. Specifically, a detector circuit includes a sensor inductor (in the form of an antenna) which wirelessly couples to the inductor of an RFID detector tag from a distance. An alternating current is applied to the detector inductor (antenna) and swept through a range of frequencies approximate to 13.56 Mhz and the signal level is measured to remotely determine the resonant frequency of the detector tag. In the absence of metal near the detector tag it is expected that the resonant frequency will be approximately the design frequency of 13.56 Mhz. However, when metal is moved proximate to the detector tag, the mutual inductance between the metal and the inductor in the detector tag will lower the effective inductance of the detector tag, raising the resonant frequency of the detector tag. The detector then determines whether the buckle is closed by determining the change in the resonant frequency. When the metal clip portion is inserted into the receptacle, thus securing the buckle, the proximity of the metal to the detector circuit lowers the resonant frequency by about 50 kHz. In the preferred embodiment frequencies are scanned frequencies every 10 kHz. The present circuitry is configured to identify large changes (plus or minus 50 khz) in the resonant frequency and to associate a large increase in resonance frequency with a “buckle closing” event and a large decrease in resonant frequency as a “buckle opening” event.

The buckle closure sensor in the preferred embodiment is a tank circuit having an inductor (in the form of an antenna) and capacitor tuned to about 13.56 MHz. The tank circuit is similar to one that would be used on an RFID tag. In fact, a commercial RFID tag can be used. In one embodiment the buckle closure sensor has no microprocessor or digital memory chip with an electronic product code. In the preferred embodiment a standard RFID tag with an onboard microprocessor is used.

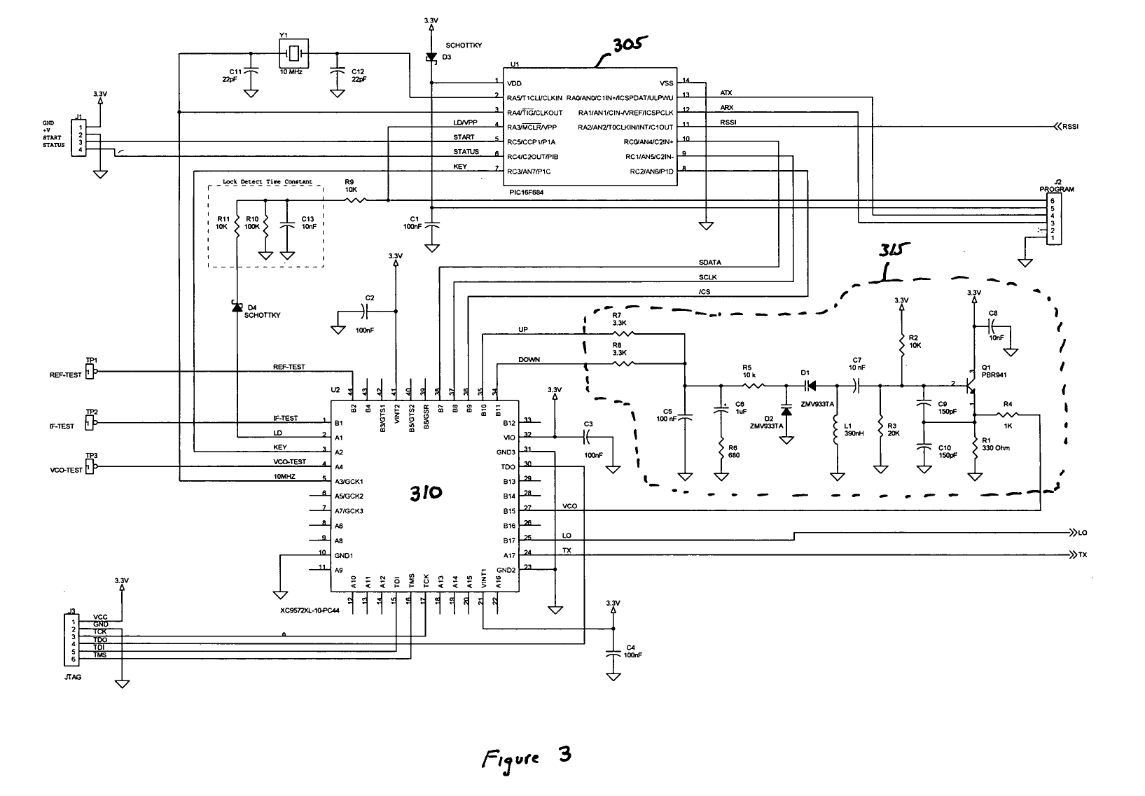

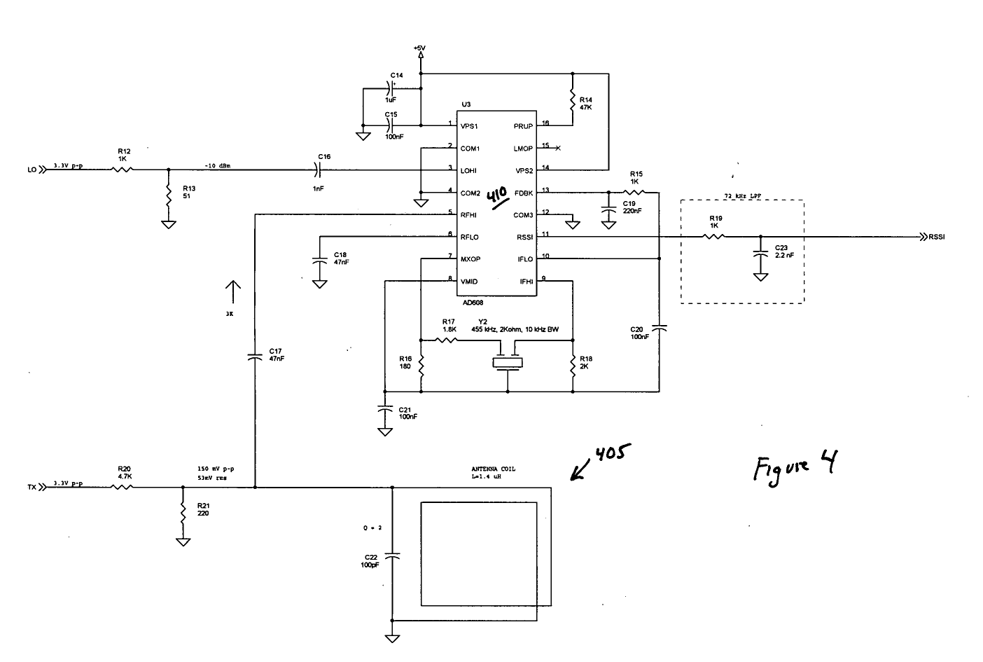

FIGS. 3 and 4 are schematic diagrams of a detector circuit in accordance with the one embodiment of the present invention. Microprocessor 305 logically controls the detector as described above and is coupled to Cmos Programmable Logic Device (CPLD) 310. CPLD 310 and associated circuitry. 315 generate a 13 Mhz signal having a frequency specified by microprocessor 305. This signal is coupled to antenna 405 illustrated in FIG. 4 and broadcast to a passive RFID tag used as a buckle-closure sensor. After the signal is broadcast the transmission is turned off and the amplitude of the return signal is measured by RF receiver 410 and the amplitude is returned to microprocessor 305 for processing and another frequency is specified and broadcast.

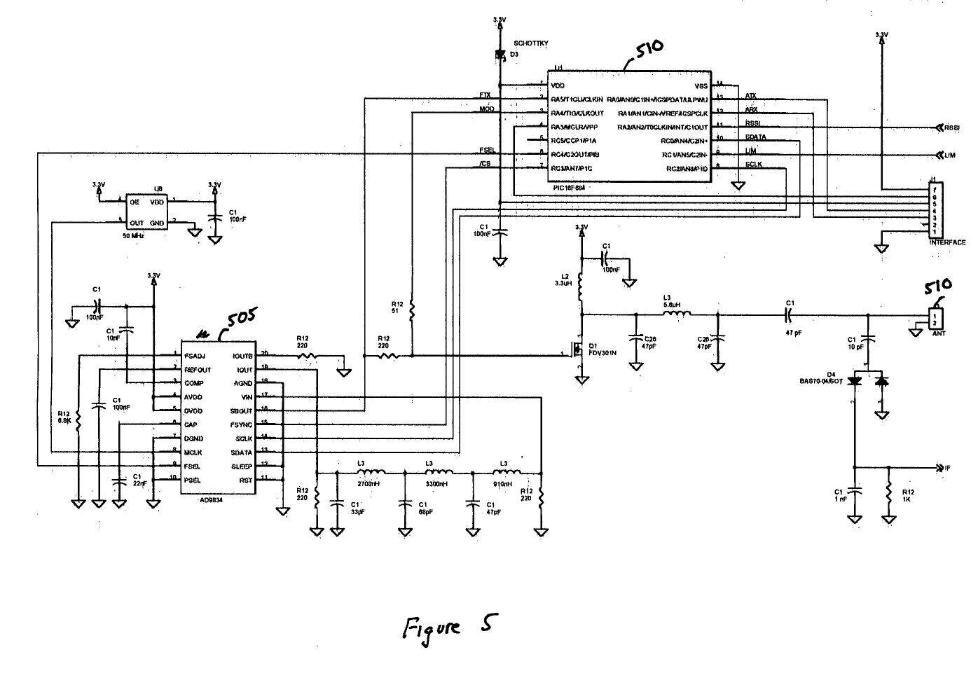

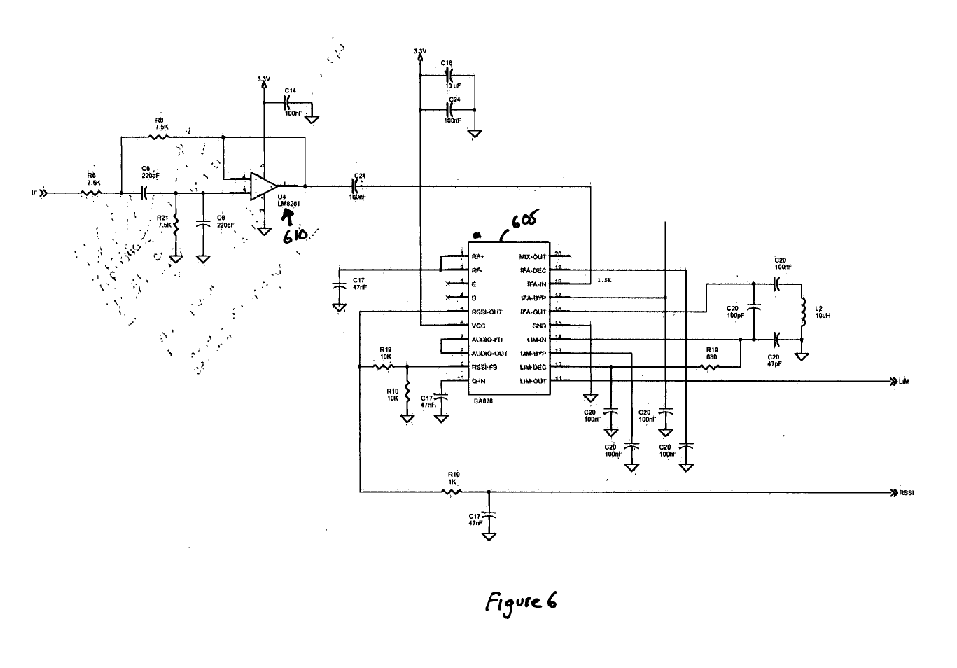

FIGS. 5 and 6 are schematic diagrams of a detector circuit in accordance with a preferred alternative embodiment of a detector circuit using an active RFID tag is used. The active RFID tag includes a microprocessor in accordance with RFID standards. The active RFID tag broadcasts data in response to a query from the detector circuit. The detector circuit can rebroadcast queries, which gives additional time to measure the amplitude of the return signal. Direct Digital Synthesizer (DDS) 505 generates the 13 Mhz broadcast signal. Microprocessor 510 modulates the RF signal with a query for the active RFID device. The modulated RF signal is applied to antenna 510. The exact query is unimportant. The active RFID device responds to the query. The amplitude of the response is detected by RF receiver 605 and returned to microprocessor 510 for processing. Operation amplifier 610 is part of a front end filter for RF receiver 605.

The active RFID tag is powered only by the transmission from the detector. Active RFID tags answer back each time they are queried. Providing repeated queries facilitates measurement of the return signal. It should be noted that while the RFID device including a microprocessor is referred to as “active,” it is only active in that it responds to queries while an interrogating broadcast signal is provided. It is still considered a “passive” device in the sense that it has no battery or power source other than the power received from broadcasts through its antenna.

Preferably the RFID tag is placed on the outside of the seat buckle. We have found that if the RFID device is placed on the side of the buckle facing the child in the seat with the buckle against the body, that the child's body de-tunes the tag in the same manner as the metal in the buckle, creating a false indication of the buckle being secured. This is most likely due to the high salt water content of the human body, which conducts rather well, and results in an effect similar to that of a metal conductor.

In one embodiment this effect may be used to advantage as a presence sensor. Specifically, a second tag can be placed under the seat and the de-tuning of this second sensor by the presence of a child's body in the seat could be used as a presence sensor. In this embodiment the buckle detector/presence sensor system would consist of a tag reader which could discriminate between two tags, reading the resonant frequency of the buckle tag to determine the status of buckle engagement and also reading the resonant frequency of the tag placed in the seat pad in the same manner to determine if a body is in the seat de-tuning the tag.

Using a tag as a presence sensor or having multiple child seats requires the detection of multiple tags. There are a number of ways to discriminate between the tags. One method is to have each tag operate at a different end of a chosen RFID frequency band. Another method is to use two intelligent tags (active tags with microprocessors) allowing the tag reader to address a particular tag and disabling any other tags during the measuring period. This would permit the differentiation of multiple child seat systems or the use of RFID tags for both buckle-closure detection and presence sensing.

In an alternative embodiment the resonant frequency measurement on a tag is performed by stepping through the 13.56 MHz RFID tag band in 1 KHz steps and measuring the signal strength of the tag's reply at each step. The resonant frequency of the tag is the frequency at which the reply signal is the highest. Alternatively, more intelligent and optimized algorithms can be used to zero in on the peak which would be faster and use less battery power.

The ZigBee standard variously referred to in the present decsription is the name of a specification for a suite of high level communication protocols using small, low-power digital radios based on the IEEE 802.15.4 standard for wireless personal area networks (WPANs). The relationship between IEEE 802.15.4-2003 and ZigBee is similar to that between IEEE 802.11 and the Wi-Fi Alliance. The ZigBee 1.0 specification was ratified on Dec. 14, 2004 and is available to members of the ZigBee Alliance. The Zigbee wireless standard operates from 902 to 928 GHz. However other types of wireless communications could be adapted in accordance with the teachings herein. For example, the communications could be provided using utilizing ultra-wideband (UWB) wireless technology, which operates from 125 KHz. to 50 GHz. Another alternative would be Radio Frequency (RF) Wireless Technologies operating from 125 KHz. to 5.8 GHz. In another embodiment, communication could operate at 2.45 GHz. utilizing 802.15.4 wireless technology. In a still a further embodiment, the Child Safety Seat System operates at 2.45 GHz. utilizing Bluetooth wireless technology. As can be appreciated, a number of wireless communications technologies could be used without departing from the teachings of the invention.

The preferred embodiment of the present invention has been taught in association with a child safety seat. However, the buckle-closure system could also be used in other buckle systems, such as seat beats on cars and child booster seats. The system could also be used in other closure or proximity detection devices. As can be appreciated, the present invention could be implemented on a number of other buckle or proximity systems without departing from the teachings of the invention.

While the invention has been described with reference to several embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the mode contemplated for carrying out this invention.

What is claimed:

1. A wireless detection system including:
a sensor antenna and a capacitor configured as a tank circuit for placement in a first position; and
a detector circuit including a detector antenna for wirelessly coupling to the sensor antenna and further including circuitry for placing an alternating current signal on the detector antenna; sweeping the signal through a range of frequencies; determining the resonant frequency of the tank circuit, and determining the presence of an inductor proximate to the sensor in response to the determined resonant frequency.

2. A child safety seat including a wireless detection system as in claim 1 for determining the status of the buckle closure.

3. A child safety seat including a wireless detection system as in claim 1 for determining the status of a child in the child safety seat.

4. A wireless proximity detection system including:
a sensor antenna and a capacitor configured as a tank circuit and
a detector circuit for wirelessly coupling to the sensor antenna and further including circuitry for placing an alternating current signal on the detector antenna; sweeping the signal through a range of frequencies; detecting the resonant frequency of the tank circuit; and determining proximity of an inductor in response to the resonant frequency.

5. A child safety seat buckle closure system including;
a sensor antenna and a capacitor configured as a tank circuit; and
a detector circuit for wirelessly coupling to the sensor antenna and further including circuitry for placing an alternating current signal on the detector antenna; sweeping the signal through a range of frequencies; detecting the amplitude of the swept signal; and determining the closure status of the buckle in response to the amplitude and frequency swept signal.
